(19) United States
(12) Patent Application Publication
(10) Pub. No.: US 2013/0145265 A1
(43) Pub. Date: Jun. 6, 2013

(54) Bookmark with Audio Playback

(71) Applicant: Nicole CUNNINGHAM, Millbrook, NY (US)

(72) Inventor: Nicole CUNNINGHAM, Millbrook, NY (US)

(21) Appl. No.: 13/309,799

(22) Filed: Dec. 2, 2011

(51) Int. Cl. G06F 3/16; G06F 3/01

(52) U.S. Cl. 715/716

(57) ABSTRACT

A bookmark device with audio playback which includes a housing, speaker, processor, memory and a user interface. The user interface allows play back of audio content stored in memory. Playback options include playing the audio content from the beginning of the audio recording in memory, pausing the audio content, playing the audio content from where the audio was last paused and repeating audio corresponding to content of a last page played.

### FIELD OF THE INVENTION

The present invention relates to a bookmark with recordable device and, in particular, a bookmark with recordable device which allows one to record and play back audio, such as audio corresponding to the text of a book.

### BACKGROUND OF THE INVENTION

Parents read stories or books to their children. The reading of books is a bonding experience between the parent and the child. The child enjoys hearing his or her parents' voice and the interaction between the parent, the child and the story being read. Often, a parent is not available, for any number of reasons, such as being away on business and, therefore, cannot read a story to his or her child. Although audio books exist in which a narrator reads the story, the narration is not in the voice of the parent.

Numerous recording devices exist which allow one to record a short greeting or message, e.g., thirty seconds. They typically are used for a short greeting, such as a greeting card. For example, U.S. Patent Application Publication No. 2007/0028496 describes a postcard with sound recorder and player. U.S. Patent Application Publication No. 2007/0058944 describes a sound producing bookmark, which has limited memory, to replay a brief audio message or song.

What is needed in the art is a device which is compact and has an easy to use interface which allows a person, such as a parent, to record the reading of a book or story, so that a child can play back the recording when the person is unavailable to read the book or story to the child.

### SUMMARY OF THE INVENTION

The present invention is directed to a unique bookmark device which includes an audio recorder with an easy to use interface. The bookmark device has sufficient memory to allow a user to record his or her voice reading a book. Advantageously, the bookmark device allows the reader to mark or index the recording so that, during playback of the recording, an audio tone is sounded to indicate to the listener that the listener should turn the page of the book to the next page. Other advantageous optional functions of various embodiments of the present bookmark device include single press functions for playing the audio content from the beginning of the audio recording, pausing the audio content, playing the audio content from the point that the audio content was last paused, and repeating audio corresponding to the audio content of the last page played. In one further specific advantageous form, the bookmark device includes a strip or elongated tail which can be inserted into a book to mark a place in the book.

The present invention, in one form, relates to a bookmark which includes a housing, a speaker, a processor, a memory and a user interface. The user interface is for selecting playback of audio content stored in memory, according to playback options comprising: a) playing the audio content from the beginning of the audio recording in memory, b) pausing the audio content, c) playing the audio content from the point the audio content was last paused, and d) repeating audio corresponding to the audio content of the last page played. The processor executes computer instructions for playing the audio content stored in the memory when selected via the user interface. Further, the processor executes instructions to send an audio tone to the speaker after the audio content, which corresponds to a current page in a book, has been played, thereby indicating when to turn the page to the next page. In addition, the processor executes instructions for jumping back to the exact beginning of a current page, upon a single user action associated with the user interface, to thereby play audio associated with the start of the current page. In addition, the processor executes instructions for restarting audio from the beginning of the recording.

In one advantageous form, a single user action results in jumping back to the exact beginning of a current page by pressing a button associated with the user interface.

In an alternative further embodiment, the processor executes instructions for recording the audio content and storing the audio content in the memory and storing a turn page index in the audio recording, whereby, during playback, the processor sends an audio tone to the speaker upon reaching the turn page index.

Advantageously, the memory is of a sufficient size to store an entire book, such as a children's book. For example, the memory includes, but is not limited to, up to two minutes of audio, ten minutes of audio, fifteen minutes of audio and thirty minutes of audio. Further, advantageously, the memory is non-volatile memory, so that the device does not need to supply power to the memory to maintain the recording. As a result, the present device will maintain the recording in memory, even if batteries, which provide power to the device during recording and playback, are removed from the device.

### BRIEF DESCRIPTION OF THE DRAWINGS

FIG. 1 is a front elevational view of a bookmark device, in accordance with the present invention.

FIG. 2 is a rear elevational view of the bookmark device of FIG. 1.

FIG. 3 is a partial rear elevational view of the bookmark device of FIG. 2, in which a battery compartment cover has been removed and a recording panel has been opened, in accordance with the present invention.

FIG. 4 is a top elevational view of the bookmark device of FIG. 1.

FIG. 5 is a side elevational view of the bookmark device of FIG. 1.

FIG. 6 is a schematic of components of the bookmark device, in accordance with one embodiment.

### DETAILED DESCRIPTION OF THE INVENTION

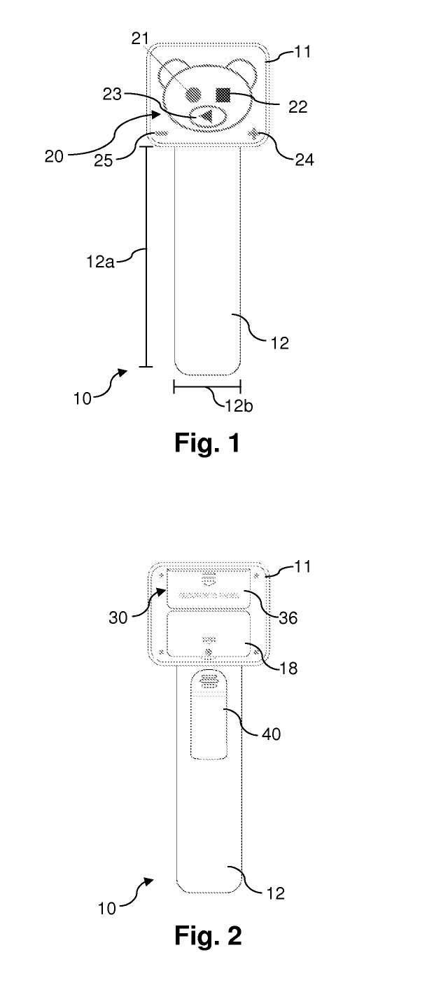

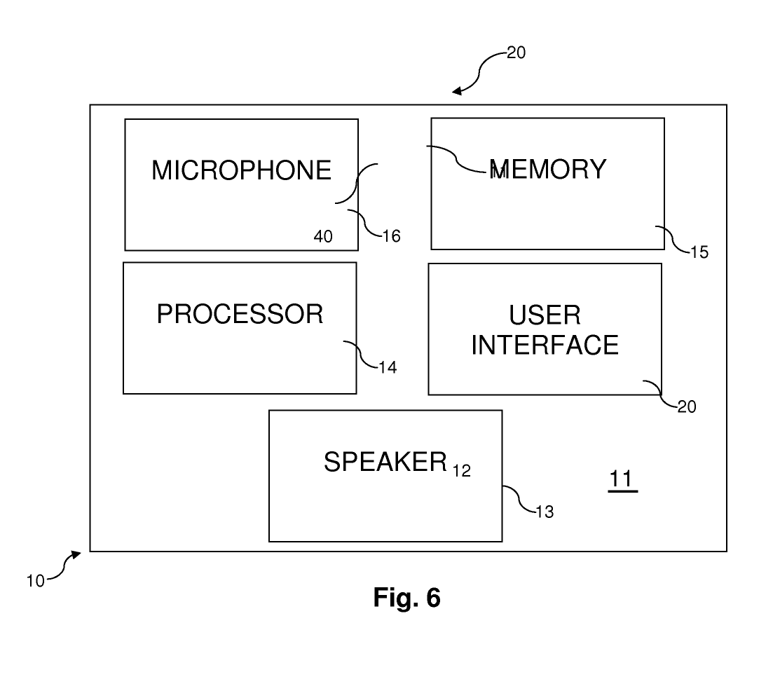

The present invention will now be described with reference to the figures. Referring specifically to FIG. 1 and FIG. 6, bookmark device 10 includes housing 11 and elongated strip 12. The elongated strip 12 is advantageously of a sufficient length and width so that the device will adequately mark a page in a book. For example, the elongated strip can have a length 12a of 5-30 centimeters and a width 12b of ½-10 centimeters. The device includes clip 40, which attaches the device to one or more pages of a book to securely fasten the device. The clip 40 has a spring (not shown) which biases the spring for attachment to one or more pages or the cover of a book.

The housing encloses a speaker 13, a computer processor 14 and a memory 15. A user interface 20 is associated with the processor 14 and includes play/pause (circle) button 21, stop/return to beginning of the recording (square) button 22 and repeat page (triangle) button 23. The user interface 20 also includes volume up plus sign (+) button 24 and volume down minus sign (−) button 25.

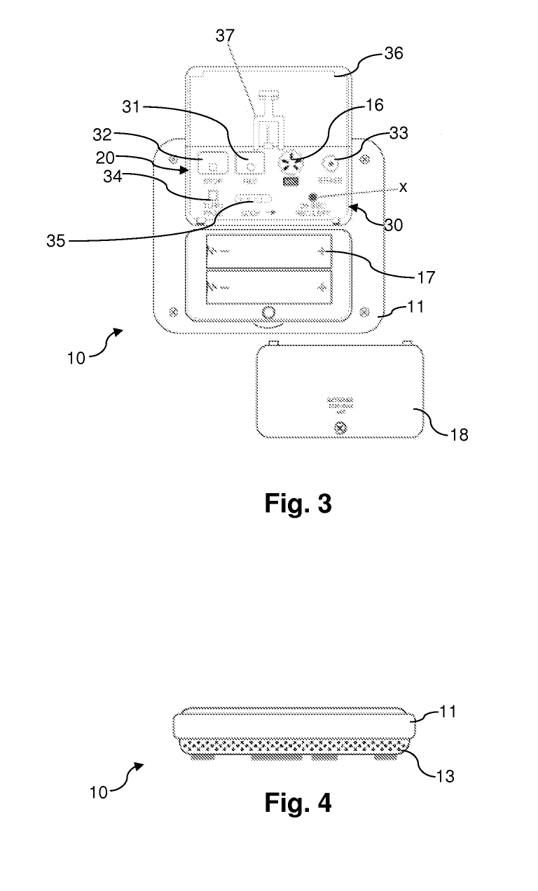

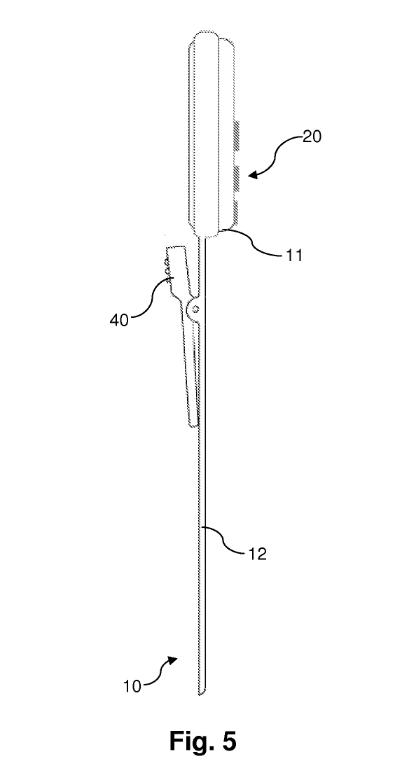

Referring now to FIGS. 2 and 3, the back of the housing 11 includes microphone 16, battery compartment 17 and battery compartment cover 18. Recording panel 30 (FIG. 3) includes several additional buttons which are part of the user interface 20. The recording buttons include record button 31, stop button 32, erase button 33 and turn page button 34. A lock switch 35 deactivates the recording functions of buttons 31, 32, 33 and 34, thus preventing inadvertent recording and erasing of previously stored content. A recording panel cover 36 is attached to a main portion of the back of the housing 11 via living hinge 37.

The bookmark device 10 allows one to record a person reading a book by using the user interface 20 in conjunction with the processor 14. A user (reader) presses record button 31 and speaks into the microphone 16 as he or she reads the book or story. The user can press stop button 32 at any point to stop the recording. When the reader reaches the end of a page and it is time to turn the page to the next page, the reader presses turn page button 34, which places a turn page index in the audio recording stored in memory 15. During playback, when the turn page index is reached, an audio tone will be played through the speaker 13 to indicate to the listener that he or she should turn to the next page. The erase button 33 allows the reader to erase a previously recorded audio content stored in memory 15. An LED 38 illuminates when there is only twenty seconds left in memory 15 for recording additional audio.

Memory 15 is advantageously non-volatile memory, which allows the memory to retain the audio content, even if power is not provided to the memory 15. Further, the memory 15 is of a sufficient size to store the audio content for an entire book. Since books have varying lengths, the device advantageously has sufficient memory 15 to store up to two minutes, ten minutes, fifteen minutes, twenty minutes or more.

A listener can play back a previously stored audio recording in memory 15 using the playback buttons of the user interface 20. Pressing the play/pause button 21 plays the audio recording stored in memory 15 from the point that the audio was last stopped. Pressing the play/pause button 21 when the audio is not being played results in playback from the point that the audio was last stopped. Pressing the play/pause button 21 while the audio is being played results in the audio being paused. Pressing the stop button 22 results in the audio recording being stopped if the audio recording is being played. The stop button 22 also functions to rewind the audio recording to the beginning, regardless of whether the audio is being played or if the audio has previously been paused at the time the stop button 22 is pressed. Pressing the repeat button 23 automatically jumps the playback to the exact beginning of the current page and plays the audio from that location in the recording. As a result, a single action, via the pressing of the repeat button 23, results in automatically replaying the current page from the beginning of the page. During playback, pressing the plus (+) button 24 increases the volume and pressing the minus (−) button 25 decreases the volume.

It will now be clear that the present bookmark device has features and advantages not found in prior devices. The present device allows a user, such as a parent, to record the reading of a book in his or her own voice for playback when he or she is not available to read the book to the child. The device has an easy to use interface which allows a child to play back a recording. The ease of use of the interface is provided by its simple buttons which allow a listener to easily replay a page from the audio content corresponding to the beginning of the page by pressing a single button. Further, the present device easily allows a reader/recorder to mark turn page locations within the audio recording, wherein, upon playback, a listener is provided with an audio tone to indicate to the listener to turn a page. Accordingly, the present device integrates a unique and novel, easy to use audio recording device, allowing a listener to play back a previously made audio recording, so that the listener can follow along in the book in a way not provided for in prior audio recording devices.

Although one advantage of the present device, in accordance with one preferred form, allows a reader to record his or her own voice reading a book, in an alternative form, the bookmark device may include a previous audio recording of a book. Further variations include the ability to download new audio content from books to the device, e.g., via Wi-Fi or computer connection (not shown), to memory 15.

Other embodiments and features of the present invention will become apparent from the following detailed description considered in conjunction with the accompanying drawings. It is to be understood, however, that the drawings are designed as an illustration only and not as a definition of the limits of the invention.

What is claimed is:

1. A bookmark device comprising:
a housing,
a speaker,
a processor,
memory for storing audio corresponding to text,
user interface for selecting playback of audio content stored in the memory, according to playback options comprising:
(a) playing the audio content from the beginning of the audio recording in memory,
(b) pausing the audio content,
(c) playing the audio content from where the audio content was last paused, and
(d) repeating audio corresponding to content of a last page played, wherein said processor executes computer instruction for:
playing the audio content stored in the memory when selected via the user interface,
sending an audio tone to the speaker, after audio content has been played corresponding to a first page in a book, thereby indicating one to flip a page to a second page,
jumping back to exactly a beginning of a current page, upon a single user action associated with the user interface, to thereby replay audio associated with the current page, and
restarting audio from a beginning of the recording.

2. The bookmark device of claim 1, wherein the single user action for jumping back to exactly the beginning of a current page is pressing a button associated with the user interface.

3. The bookmark device of claim 1, wherein the processor further executes instructions for:
recording the audio content and storing audio content in the memory, and
storing a turn page index in the audio recording stored in memory, whereby, during playback, the processor sends an audio tone to the speaker after reaching the turn page index.

4. The bookmark device of claim 1, wherein the memory is of a sufficiently size to store audio for an entire book.

5. The bookmark device of claim 1, wherein the memory stores up to two minutes of audio.

6. The bookmark device of claim 1, wherein the memory stores up to ten minutes of audio.

7. The bookmark device of claim 1, wherein the memory stores up to fifteen minutes of audio.

8. The bookmark device of claim 1, wherein the memory stores up to twenty minutes of audio.

9. The bookmark device of claim 1, further comprising an elongated strip extending from the housing, said strip having a length between five centimeters and 30 centimeters and a width between one half a centimeter and ten centimeters.

10. The bookmark device of claim 9, further comprising a clip attached to the strip for attaching the bookmark device to a book.

11. The bookmark device of claim 1, wherein the memory is non-volatile memory.
